(19) United States
(12) Patent Application Publication
(10) Pub. No.: US 2025/0355735 A1
(43) Pub. Date: Nov. 20, 2025

(54) METHOD AND APPARATUS FOR SPILLING DATA INTO SHARED MEMORY, COMPUTER DEVICE AND STORAGE MEDIUM

(71) Applicant: Glenfly Tech Co., Ltd., Shanghai (CN)

(72) Inventors: Feng WANG, Shanghai (CN); Huaisheng ZHANG, Shanghai (CN); Zhongyu TAO, Shanghai (CN); Zhulin CHANG, Shanghai (CN)

(21) Appl. No.: 19/195,164

(22) Filed: Apr. 30, 2025

(30) Foreign Application Priority Data
May 16, 2024 (CN) 202410613447.X

(51) Int. Cl. G06F 9/54; G06F 12/10

(52) U.S. Cl. CPC G06F 9/544; G06F 12/10

(57) ABSTRACT

Disclosed are a method and apparatus for spilling data into a shared memory, a computer device, a computer-readable storage medium and a computer program product. The method includes: obtaining shared memory state information and spill state information of virtual register data to be spilled, the shared memory state information including memory address data and memory capacity data of at least one workgroup; calculating available address data according to the memory capacity data, the available address data representing a remaining capacity of the shared memory; calculating a virtual register spill amount according to the spill state information; calculating a target storage space according to the virtual register spill amount and the memory address data; determining a shared memory availability condition according to the available address data; and storing the virtual register data to be spilled into the target storage space when the target storage space meets the shared memory availability condition.

### CROSS-REFERENCE TO RELATED APPLICATIONS

The present application claims priority to Chinese patent application No. 202410613447X, filed on May 16, 2024, the entire content of which is incorporated herein by reference.

### TECHNICAL FIELD

The present disclosure relates to the field of computer applications, and in particular, to a method and apparatus for spilling data into a shared memory, a computer device, a storage medium and a computer program product.

### BACKGROUND

When a compiler allocates virtual registers to physical registers, if the physical registers are not enough, the data of the virtual registers needs to be spilled. The conventional spilling method is to store the data of the virtual registers into an external memory, and then load the data back from the external memory when the data is accessed again. The external memory is large enough to ensure that the data can be stored even if a large number of data spill. However, the data store/load path is long and has a large latency, which easily causes subsequent instructions to wait and bubbles to form in the execution pipeline, thus reducing the overall running efficiency of the program.

### SUMMARY

Based on this, it is necessary to provide a method and apparatus for spilling data into a shared memory, a computer device, a computer-readable storage medium and a computer program product that can improve the overall running efficiency of the program for the above technical problems.

In a first aspect, the present disclosure provides a method for spilling data into a shared memory. The method includes:
obtaining shared memory state information and spill state information of virtual register data to be spilled, the shared memory state information including memory address data and memory capacity data of at least one workgroup;
calculating available address data according to the memory capacity data, the available address data representing a remaining capacity of the shared memory;
calculating a virtual register spill amount according to the spill state information;
calculating a target storage space of the shared memory according to the virtual register spill amount and the memory address data; and
determining a shared memory availability condition according to the available address data, and storing the virtual register data to be spilled in the target storage space of the shared memory when the target storage space meets the shared memory availability condition.

In an embodiment, calculating the target storage space according to the virtual register spill amount and the memory address data includes:
obtaining a shared memory base address according to the memory address data;
calculating a memory offset address according to the memory capacity data and the shared memory base address; and
determining the target storage space according to the virtual register spill amount and the memory offset address.

In an embodiment, the memory address data includes a local address of a corresponding workgroup, and obtaining the shared memory base address according to the memory address data includes:
directly obtaining the shared memory base address according to the local address;
calculating, when the shared memory base address does not exist, the shared memory base address according to the memory address data and the memory capacity data; and
storing the shared memory base address in correspondence with the local address of the corresponding workgroup.

In an embodiment, the method is applied to a single processing element, the processing element includes at least one workgroup, each workgroup includes at least one work item, the memory capacity data includes a total shared memory capacity of the processing element, a currently occupied shared memory capacity of each workgroup, and a set memory capacity of each work item in each workgroup, and calculating the shared memory base address according to the memory address data and the memory capacity data includes:
determining base address start data according to the total shared memory capacity and the currently occupied shared memory capacity; and
calculating the shared memory base address according to the base address start data and the set memory capacity.

In an embodiment, storing the virtual register data to be spilled in the target storage space of the shared memory includes:
obtaining a life cycle of the virtual register data to be spilled; and
storing the virtual register data to be spilled in the target storage space of the shared memory according to the life cycle.

In an embodiment, the life cycle includes a start time node and an end time node, and storing the virtual register data to be spilled in the target storage space according to the life cycle includes:
storing the virtual register data to be spilled in the target storage space at the start time node; and
releasing the target storage space at the end time node.

In a second aspect, the present disclosure further provides an apparatus for spilling data into a shared memory. The apparatus includes:
an information obtaining module configured to obtain shared memory state information and spill state information of virtual register data to be spilled, the shared memory state information including memory address data and memory capacity data of at least one workgroup;
a capacity calculation module configured to calculate available address data according to the memory capacity data, the available address data representing a remaining capacity of the shared memory;
a spill amount calculation module configured to calculate a virtual register spill amount according to the spill state information;
a space determination module configured to calculate a target storage space according to the virtual register spill amount and the memory address data; and
a data storage module configured to determine a shared memory availability condition according to the available address data, and store the virtual register data to be spilled in the target storage space when the target storage space meets the shared memory availability condition.

In a third aspect, the present disclosure further provides a computer device including a memory and a processor. The memory stores a computer program, and the processor, when executing the computer program, implements the following steps:
obtaining shared memory state information and spill state information of virtual register data to be spilled, the shared memory state information including memory address data and memory capacity data of at least one workgroup;
calculating available address data according to the memory capacity data, the available address data representing a remaining capacity of the shared memory;
calculating a virtual register spill amount according to the spill state information;
calculating a target storage space according to the virtual register spill amount and the memory address data; and
determining a shared memory availability condition according to the available address data, and storing the virtual register data to be spilled in the target storage space when the target storage space meets the shared memory availability condition.

In a fourth aspect, the present disclosure further provides a non-transitory computer-readable storage medium having a computer program stored therein. When the computer program is executed by a processor, the following steps are implemented:
obtaining shared memory state information and spill state information of virtual register data to be spilled, the shared memory state information including memory address data and memory capacity data of at least one workgroup;
calculating available address data according to the memory capacity data, the available address data representing a remaining capacity of the shared memory;
calculating a virtual register spill amount according to the spill state information;
calculating a target storage space according to the virtual register spill amount and the memory address data; and
determining a shared memory availability condition according to the available address data, and storing the virtual register data to be spilled in the target storage space when the target storage space meets the shared memory availability condition.

In a fifth aspect, the present disclosure further provides a computer program product including a computer program. When the computer program is executed by a processor, the following steps are implemented:
obtaining shared memory state information and spill state information of virtual register data to be spilled, the shared memory state information including memory address data and memory capacity data of at least one workgroup;
calculating available address data according to the memory capacity data, the available address data representing a remaining capacity of the shared memory;
calculating a virtual register spill amount according to the spill state information;
calculating a target storage space according to the virtual register spill amount and the memory address data; and
determining a shared memory availability condition according to the available address data, and storing the virtual register data to be spilled in the target storage space when the target storage space meets the shared memory availability condition.

### BRIEF DESCRIPTION OF THE DRAWINGS

In order to describe the technical solutions of the embodiments of the present disclosure or the related art more clearly, the accompanying drawings required for describing the embodiments or for describing the related art will be briefly introduced as follows. Apparently, the accompanying drawings, in the following description, illustrate merely some embodiments of the present disclosure, for a person of ordinary skill in the art, other drawings can also be obtained according to these accompanying drawings without making any creative efforts.

FIG. 1 is a diagram showing an application environment of a method for spilling data to a shared memory in an embodiment.

FIG. 2 is a schematic flowchart of a method for spilling data to a shared memory in an embodiment.

FIG. 3 is a schematic flowchart of the step S208 in the method for spilling data to a shared memory in an embodiment.

FIG. 4 is a schematic diagram showing an occupancy of a shared memory (SM) in an embodiment.

FIG. 5 is a schematic diagram showing a mapping relationship when data spills in an embodiment.

FIG. 6 is a schematic diagram showing a spill allocation result in an embodiment.

FIG. 7 is a block diagram showing a configuration of an apparatus for spilling data to a shared memory in an embodiment.

FIG. 8 is a diagram showing an internal configuration of a computer device in an embodiment.

FIG. 9 is a diagram showing an internal configuration of a computer device in another embodiment.

### DETAILED DESCRIPTION OF THE EMBODIMENTS

In order to make the objectives, technical solutions and advantages of the present disclosure more clearly understood, the present disclosure will be further described in detail with the accompanying drawings and embodiments. It should be understood that the specific embodiments described herein are only used to explain the present disclosure and not to limit the present disclosure.

Memory access and instruction execution are two important factors that affect program running performance. A good match between the memory access and the instruction execution enables full play of software and hardware performance, and facilitates to improve the program running performance under the same hardware condition. In a hierarchical structure of a memory with a general architecture, an access speed of a register is greater than that of a static random-access memory (SRAM), and the access speed of the SRAM is greater than that of an external memory. Therefore, the register and the SRAM are used as much as possible to improve their utilization rate, which has a positive impact on performance improvement. When a shared memory (SM) is taken as the SRAM, a compiler can reasonably utilize the unoccupied SM in the program when the register space is insufficient, so as to improve the program running performance. Register allocation is an important step in the compiler process. The unlimited virtual registers are allocated to the limited physical registers as much as possible through a time-sharing multiplexing method. When not all virtual registers can be allocated to the physical registers, a spill occurs, resulting in a load/store action.

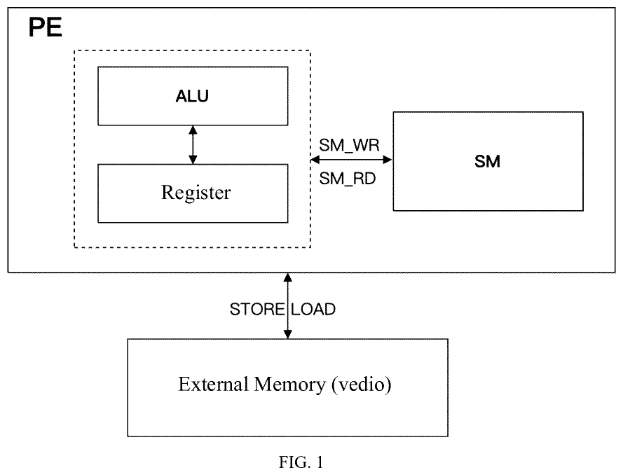

A method for spilling data to a shared memory provided in an embodiment of the present disclosure can, exemplarily, be applied to a processing element in a server. An open computing language (OpenCL) is taken as a heterogeneous programming platform, a central processing unit (CPU) is taken as a host side, a graphics processing unit (GPU) is taken as a device side, and a low-level virtual machine (LLVM) is taken as a compilation framework. The method can be applied to an application environment shown in FIG. 1. In a processing element (PE), the register is closest to an arithmetic logic unit (ALU) and has the fastest access speed. The SM is also inside the PE, close to the ALU, and has a relatively fast access speed. The external memory is outside the PE, farthest from the ALU, and the access speed of the external memory is much slower than that of the SM. The embodiment of the present disclosure takes the LLVM compiler as an example to illustrate the storage implementation process of spilling to the SM. The above-mentioned server can be implemented by an independent server or a server cluster consist of multiple servers.

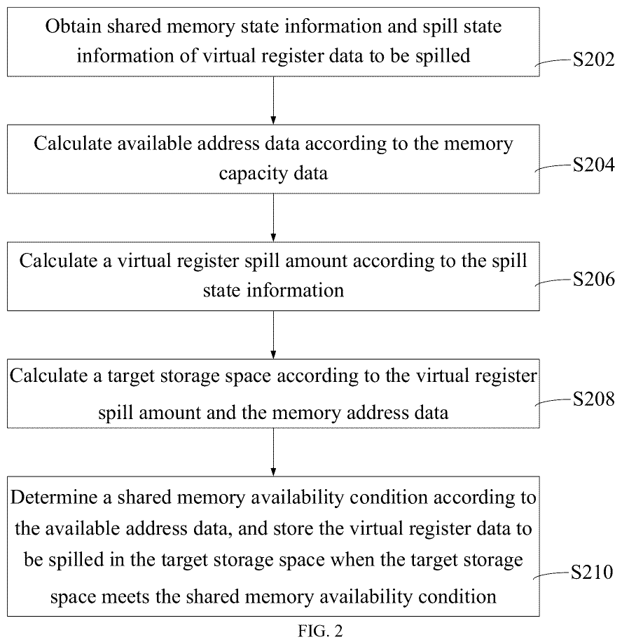

In an exemplary embodiment, as shown in FIG. 2, a method for spilling data to a shared memory is provided. Taking the method applied to the PE in FIG. 1 as an example for illustration, the method includes the following steps S202 to S210.

In step S202, shared memory state information and spill state information of virtual register data to be spilled are obtained.

The shared memory state information includes memory address data and memory capacity data of at least one workgroup. This embodiment provides a case that only one workgroup is included. In a case that a plurality of workgroups are included, working parameters of the plurality of workgroups are allocated by the corresponding hardware parts. The memory address data represents address information of each workgroup or work item in the PE allocated and managed by the hardware. The memory capacity data represents capacity-related data of each workgroup or work item in the PE. The memory capacity data may include at least one of a total shared memory capacity of the PE, a currently occupied shared memory capacity of each workgroup, or a set memory capacity of each work item in the workgroup.

Exemplarily, the PE may obtain the shared memory state information from a logging module. The logging module is configured to record storage change events occurring in the PE. The PE may obtain the current shared memory state information according to log information provided by the logging module, thereby obtaining the memory address data and the memory capacity data of the at least one workgroup. Exemplarily, the PE may receive the virtual register data to be spilled and the corresponding spill state information from a virtual register allocation module. The virtual register allocation module is configured to allocate and store the virtual register data.

The logging module and the virtual register allocation module can be implemented in whole or in part by software, hardware, or combinations thereof. Each of the above modules may be embedded or independent of the processing element in a form of hardware, or may be stored in a memory in a form of software, so as to be called to perform the operations corresponding to the modules.

In step S204, available address data is calculated according to the memory capacity data.

The available address data represents a remaining capacity of the shared memory.

In some embodiments, the available address data is calculated according to a total shared memory space of the single PE in the GPU, a shared memory space already occupied by programs, a shared memory space already occupied by local parameters, and a number of workgroups included in the PE.

Exemplarily, it is assumed that a total shared memory space of the single PE in the GPU is denoted as M, a SM space already occupied by the program is denoted as a, a SM space already occupied by local parameters is denoted as b, and a number of workgroups included in the PE is denoted as N, then a SM space G that a single workgroup can use for spill is calculated according to the following formula: G=M/N−a−b.

In step S206, a virtual register spill amount is calculated according to the spill state information.

Exemplarily, the PE spills the virtual register that cannot be allocated to the physical register through algorithm calculation by using the LLVM compilation framework, so as to obtain the virtual register. During the register allocation phase of the compilation process, the compiler attempts to allocate the virtual registers in the program to the physical registers. The number of the physical registers is limited. When the number of the virtual registers in the program exceeds the number of the physical registers, i.e., during the allocation process, when a virtual register cannot be allocated to a physical register, the compiler identifies these unallocated virtual registers and mark them as requiring spill processing. For these virtual registers marked as requiring spill, the compiler generates the spill state information synchronously. Further, the PE calculates the virtual register spill amount according to the spill state information.

In step S208, a target storage space of the shared memory is calculated according to the virtual register spill amount and the memory address data.

Exemplarily, according to information provided by an analysis tool of the compiler in the above step, the PE calculates the spill amount of the virtual register, i.e., the amount of data that cannot be allocated to physical registers and needs to be stored in the memory, and calculate a size of the target storage space that needs to be allocated to the virtual register, which is equal to the spill amount of the virtual register.

In step S210, a shared memory availability condition is determined according to the available address data, and the virtual register data to be spilled is stored in the target storage space of the shared memory when the target storage space meets the shared memory availability condition.

Exemplarily, the shared memory availability condition is that the capacity of the target storage space is greater than or equal to the remaining capacity of the shared memory. When the target storage space does not meet the shared memory availability condition, the PE spills the virtual register data to the memory or external memory in a conventional approach.

In the above method for spilling data to a shared memory, the memory address data and the memory capacity data of the at least one workgroup are obtained by obtaining the shared memory state information and the spill state information of the virtual register data to be spilled, and then the available address data is calculated according to the memory capacity data, thereby obtaining the remaining capacity of the shared memory. Then, the shared memory availability condition is determined according to the available address data. Further, the virtual register spill amount is calculated according to the spill state information, and then the target storage space is calculated according to the virtual register spill amount and the memory address data, thereby determining whether the target storage space meets the shared memory availability condition. When the target storage space meets the shared memory availability condition, it can be determined that the shared memory in the PE can receive the virtual register data to be spilled, and then the virtual register data to be spilled is stored in the target storage space. During the register allocation process, for a scenario where the physical registers are insufficient, the compiler first tries to spill the virtual register data to the shared memory that is not occupied by the program, instead of storing the virtual register data in the external memory. Since the shared memory is a storage region within the processor, it has the characteristics of short data path and high efficiency, thereby improving the overall running efficiency of the program.

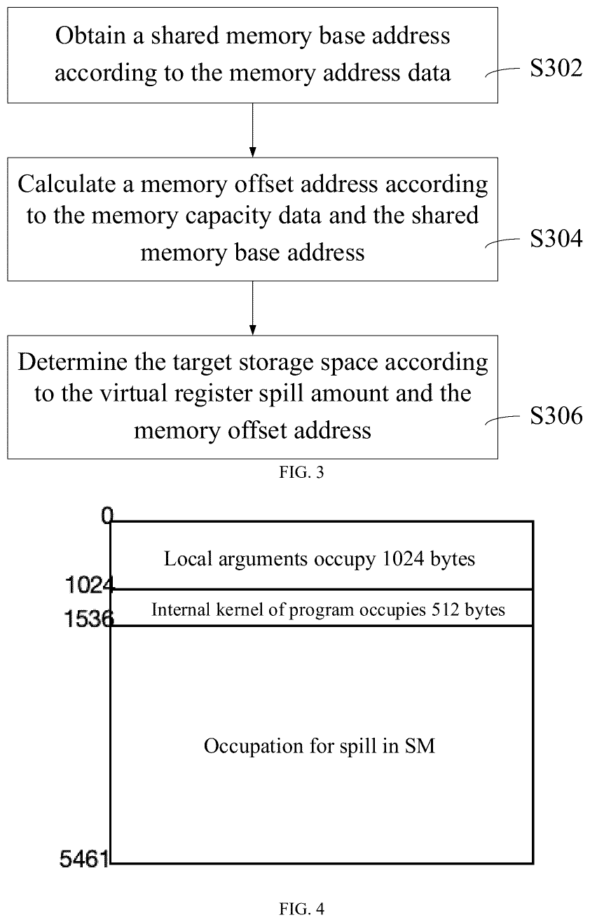

In an exemplary embodiment, as shown in FIG. 3, step S208 includes the following steps S302 to S306.

In step S302, a shared memory base address is obtained according to the memory address data.

The memory address data includes a local address of a corresponding workgroup.

Exemplarily, the method can be applied to the single PE. The PE includes at least one workgroup, and each workgroup includes at least one work item. The memory capacity data includes the total shared memory capacity of the PE, the currently occupied shared memory capacity of each workgroup, and the set memory capacity of each work item in the workgroup. The PE may determine base address start data according to the total shared memory capacity and the currently occupied shared memory capacity, and then calculate the shared memory base address based on the base address start data and the set memory capacity.

Furthermore, it is assumed that the local address of the workgroup is denoted as local_id=[x, y,z], and the set memory capacity of the work item is denoted as local_work_size=[X, Y, Z], so that the shared memory base address of the spill corresponding to work item (x, y, z) may be calculated, and is denoted as base=((a+b)+X*Y*z+Y*x+y).

It should be emphasized that since three variables on which the calculation of the base address of the work item depends are constant for each work item, the three variables only need to be calculated once, and there is no need to repeat the calculation every time a spill occurs. Therefore, the calculation of the base address is executed in the entry BB (basic block) of the compiled program. After the calculation is completed, the base address is stored in a designated register for subsequent spill utilization. Exemplarily, the PE may directly obtain the shared memory base address according to the local address. When the shared memory base address does not exist, the PE calculates the shared memory base address according to the memory address data and the memory capacity data, and stores the shared memory base address in correspondence with the local address of the corresponding workgroup.

In the step S304, a memory offset address is calculated according to the memory capacity data and the shared memory base address.

In the step S306, the target storage space is determined according to the virtual register spill amount and the memory offset address.

Exemplarily, a start address of the shared memory is a start address capable of storing the virtual register data to be spilled, and the start address consists of a base address and an offset address. The compiler only needs to calculate address information of the single workgroup. When the number N of the workgroups is greater than 1, the base addresses of different workgroups are allocated and managed by the hardware. The target storage space is a storage space for storing spill data, and is calculated according to the start address of the shared memory and the virtual register spill amount.

Exemplarily, the PE calculates a size of the virtual register according to a type (such as i32, float, etc.) and a dimension (one-dimensional x, two-dimensional (x, y), four-dimensional (x, y, z, w), etc.) of the virtual register to be spilled. The size of the virtual register is set to S, and the memory offset address that can store the virtual register is determined, thereby calculating the target storage space.

In an exemplary embodiment, in the LLVM compilation framework, a start/end life cycle of the virtual register may be obtained during spill. The step S210 includes: obtaining a life cycle of the virtual register data to be spilled; and storing the virtual register data to be spilled in the target storage space according to the life cycle.

The life cycle includes a start time node and an end time node.

Exemplarily, the PE stores the virtual register data to be spilled in the target storage space at the starting time node, and releases the target storage space at the end time node, thereby reusing the spill space of the shared memory according to a conflict relationship of the life cycle, further improving the utilization rate of the shared memory and improving the overall running efficiency of the program.

In another exemplary embodiment, it is assumed that the total SM space M of the single PE in the GPU is 32 KB, i.e., 32768 bytes, the SM space a occupied by the program is 512 bytes, the SM space b occupied by the local parameters is 1024 bytes, and the number N of workgroups is 6. There are 128 work items in a workgroup, and there are 32 work items in each thread (wave), i.e., there are 4 waves in the workgroup. In this case, in the single workgroup, it is set that the memory space local_work_size is [32, 8, 1].

It is assumed that the data of the virtual registers shown in Table 1 below need to be spilled sequentially.

TABLE 1

| Virtual | | SM space required for | SM space required for 4 |
|---|---|---|---|
| Register | Data Type | a single wave (Byte) | waves (Byte) |
| Vx | float | 4*32 = 128 | 4*32*4 = 512 |
| Vy | float2 | 4*2*32 = 256 | 4*2*32*4 = 1024 |
| Vz | int | 4*32 = 128 | 4*32*4 = 512 |
| Vp | float4 | 4*4*32 = 512 | 4*4*32*4 = 2048 |
| Vw | int2 | 4*2*32 = 256 | 4*2*32*4 = 1024 |

Further, the PE calculates that the available SM space G for each group is the quotient of 32768 and 6, i.e., 5461 bytes, and the start address that can be used for spill is the sum of 1024 and 512, i.e., 1536 bytes. Before the virtual register is spilled, an occupancy of the SM is shown in FIG. 4. The base address of the work item is calculated and denoted as: base=(a+b)+X*Y*z+Y*x+y=1536+256*z+8*x+y. After mapping, the address of the work item with (x, y, z) being (0,0,0) will be mapped to the location of the 1536 bytes of the SM.

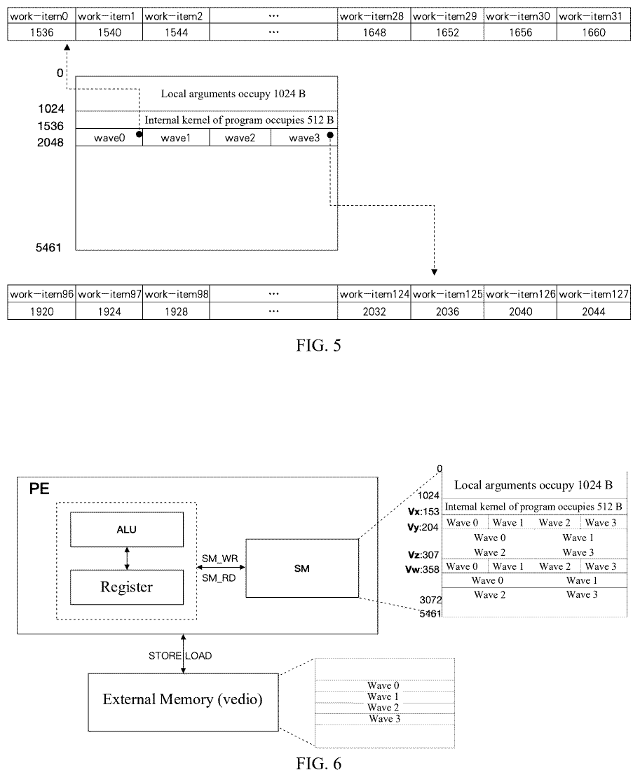

Furthermore, as shown in FIG. 5, taking Vx (the data type of which is float, and the dimension of which is one-dimensional) as an example for illustration, the base address of each work-item will eventually be mapped to the start position at 1536 bytes of the SM and arranged sequentially, i.e., the base address of work-item 0 is 1536, the base address of work-item 1 is a value of (1536+4*1), which is equal to 1540, and the base address of work-item 255 is a value of (1536+4*127), which is equal to 2044.

Vx is the first virtual register that is spilled to the SM, and its offset address is 0, then the address of work-item 0 of Vx is denoted as: SMVx=1536+0, i.e., the total start address of Vx is 1536. The size of the virtual register is calculated according to the type (data type is float) and dimension (one-dimensional) of the virtual register, and the size is set to S. Since the sum of the offset address and the size S is less than or equal to G in this case, the target storage space meets the shared memory availability condition, so the virtual register Vx can be spilled into the SM space. As a result, the storage implementation process of the spill is completed, and a spill allocation result is shown in FIG. 6.

It should be understood that although the individual steps in the flow diagrams involved of the embodiments as described above are shown sequentially as indicated by arrows, the steps are not necessarily performed sequentially in the order indicated by the arrows. Unless explicitly stated herein, the execution of these steps is not strictly limited in order and these steps can be performed in any other order. Moreover, at least some of the steps in the flow diagrams involved of the embodiments as described above may include a plurality of steps or a plurality of stages that are not necessarily performed at the same time, but may be performed at different times. The order in which these steps or stages are performed is not necessarily sequential, and these steps may be performed alternately or alternately with other steps or at least some of the steps or stages in other steps.

Based on the same inventive concept, embodiments of the present disclosure also provide an apparatus for spilling data into a shared memory for implementing the method for spilling data into a shared memory as described above. The solution to the problem provided by the apparatus is similar to the implementation of the method documented above, so the specific features in the one or more embodiments of the apparatus for spilling data into a shared memory provided below may be understood with reference to the features of the method for spilling data into a shared memory above and will not be repeated here.

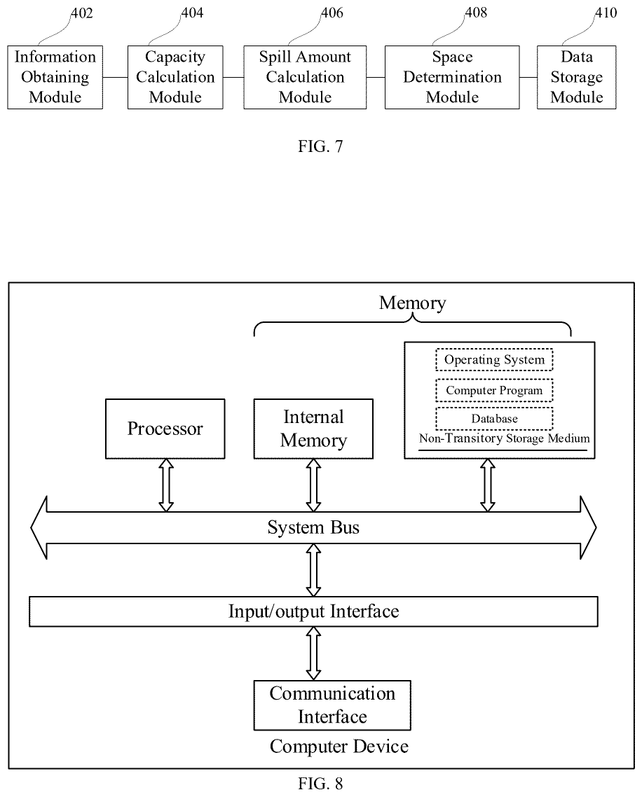

In an exemplary embodiment, as shown in FIG. 7, an apparatus for spilling data into a shared memory is provided, including: an information obtaining module 402, a capacity calculation module 404, a spill amount calculation module 406, a space determination module 408 and a data storage module 410.

The information obtaining module 402 is configured to obtain shared memory state information and spill state information of virtual register data to be spilled. The shared memory state information includes memory address data and memory capacity data of at least one workgroup.

The capacity calculation module 404 is configured to calculate available address data according to the memory capacity data. The available address data represents a remaining capacity of the shared memory.

The spill amount calculation module 406 is configured to calculate a virtual register spill amount according to the spill state information.

The space determination module 408 is configured to calculate a target storage space according to the virtual register spill amount and the memory address data.

The data storage module 410 is configured to determine a shared memory availability condition according to the available address data, and store the virtual register data to be spilled in the target storage space when the target storage space meets the shared memory availability condition.

In an embodiment, the space determination module 408 includes a base address obtaining unit, an offset address, and a target determination unit.

The base address obtaining unit is configured to obtain a shared memory base address according to the memory address data.

The offset address calculation unit is configured to calculate a memory offset address according to the memory capacity data and the shared memory base address.

The target determination unit is configured to determine the target storage space according to the virtual register spill amount and the memory offset address.

In an embodiment, the memory address data includes a local address of a corresponding workgroup. The base address obtaining unit is further configured to: directly obtain the shared memory base address according to the local address; calculate, when the shared memory base address does not exist, the shared memory base address according to the memory address data and the memory capacity data; and store the shared memory base address in correspondence with the local address of the corresponding workgroup.

In an embodiment, the apparatus is applied to a single processing element. The processing element includes at least one workgroup, each workgroup includes at least one work item, and the memory capacity data includes a total shared memory capacity of the processing element, a currently occupied shared memory capacity of each workgroup, and a set memory capacity of each work item in each workgroup. The base address obtaining unit is further configured to: determine base address start data according to the total shared memory capacity and the currently occupied shared memory capacity; and calculate the shared memory base address according to the base address start data and the set memory capacity.

In an embodiment, the data storage module 410 includes the following units a cycle obtaining unit and a data storage unit.

The cycle obtaining unit is configured to obtain a life cycle of the virtual register data to be spilled.

The data storage unit is configured to store the virtual register data to be spilled in the target storage space according to the life cycle.

In an embodiment, the life cycle includes a start time node and an end time node. The data storage unit is further configured to store the virtual register data to be spilled in the target storage space at the start time node; and release the target storage space at the end time node.

The individual modules in the above apparatus for spilling data into a shared memory can be implemented in whole or in part by software, hardware and combinations thereof. Each of the above modules may be embedded in hardware form or independent of a processor in a computer device, or may be stored in software form on a memory in the computer device so that the processor can be called to perform the operations corresponding to each of the above modules.

In an exemplary embodiment, a computer device is provided, which may be a server. A diagram illustrating an internal configuration of the computer device may be shown in FIG. 8. The computer device includes a processor, a memory, an input/output (I/O) interface, and a communication interface. The processor, the memory and the input/output interface are connected via a system bus, and the communication interface is connected to the system bus via the input/output interface. The processor of the computer device is configured to provide computing and control capabilities. The memory of the computer device includes a non-transitory storage medium and an internal memory. The non-transitory storage medium stores operating systems and computer programs. The internal memory provides an environment for the operation of the operating systems and the computer programs in the non-transitory storage medium. The database of the computer device is configured to store shared memory state information, life cycle information of virtual registers, and the like. The input/output interface of the computer device is configured to exchange information between the processor and external devices. The communication interface of the computer device is configured to communicate with external terminals via a network connection. The computer programs are executed by the processor in order to implement the method for spilling data to a shared memory.

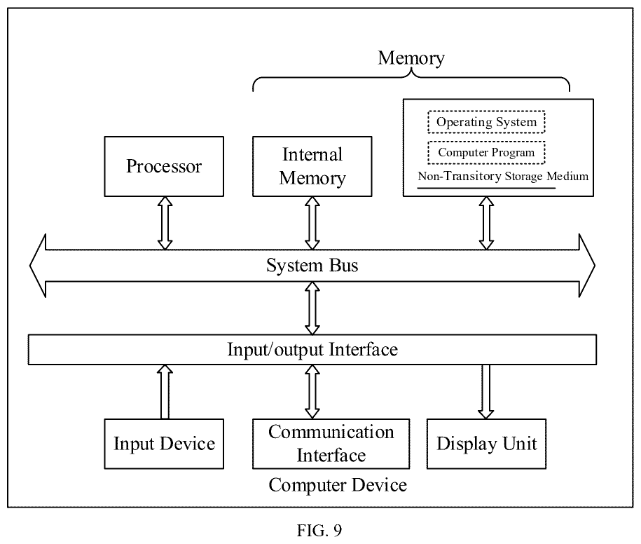

In an exemplary embodiment, a computer device is provided, which may be a terminal. A diagram illustrating an internal configuration of the computer device may be shown in FIG. 9. The computer device includes a processor, a memory, an input/output interface, a communication interface, a display unit, and an input device. The processor, the memory and the input/output interface are connected via a system bus, and the communication interface, the display unit and the input device are connected to the system bus via the input/output interface. The processor of the computer device is configured to provide computing and control capabilities. The memory of the computer device includes a non-transitory storage medium and an internal memory. The non-transitory storage medium stores operating systems and computer programs. The internal memory provides an environment for the operation of the operating systems and the computer programs in the non-transitory storage medium. The input/output interface of the computer device is configured to exchange information between the processor and external devices. The communication interface of the computer device is configured to communicate with external terminals in wired or wireless mode, which can be realized by WIFI, mobile cellular network, near field communication (NFC) or other technologies. The computer programs are executed by the processor in order to implement the method for spilling data to a shared memory.

It should be understood by a person of ordinary skill in the art that the configuration illustrated in FIG. 9 is only a block diagram of part of the configuration related to the solution of the present disclosure, and does not constitute a limitation on the computer device to which the solution of the present disclosure is applied. A specific the computer device may include more or less components than those shown in the figure, or may combine some components, or may have a different arrangement of components.

In an exemplary embodiment, a computer device is provided, including a memory and a processor. The memory stores a computer program, and the processor, when executing the computer program, implements the following steps: obtaining shared memory state information and spill state information of virtual register data to be spilled, the shared memory state information including memory address data and memory capacity data of at least one workgroup; calculating available address data according to the memory capacity data, the available address data representing a remaining capacity of the shared memory; calculating a virtual register spill amount according to the spill state information; calculating a target storage space according to the virtual register spill amount and the memory address data; and determining a shared memory availability condition according to the available address data, and storing the virtual register data to be spilled in the target storage space when the target storage space meets the shared memory availability condition.

In an embodiment, the processor, when executing the computer program, further implements the following steps: obtaining a shared memory base address according to the memory address data; calculating a memory offset address according to the memory capacity data and the shared memory base address; and determining the target storage space according to the virtual register spill amount and the memory offset address.

In an embodiment, the processor, when executing the computer program, further implements the following steps: directly obtaining the shared memory base address according to the local address; calculating, when the shared memory base address does not exist, the shared memory base address according to the memory address data and the memory capacity data; and storing the shared memory base address in correspondence with the local address of the corresponding workgroup.

In an embodiment, the processor, when executing the computer program, further implements the following steps: determining base address start data according to the total shared memory capacity and the currently occupied shared memory capacity; and calculating the shared memory base address according to the base address start data and the set memory capacity.

In an embodiment, the processor, when executing the computer program, further implements the following steps: obtaining a life cycle of the virtual register data to be spilled; and storing the virtual register data to be spilled in the target storage space according to the life cycle.

In an embodiment, the processor, when executing the computer program, further implements the following steps: storing the virtual register data to be spilled in the target storage space at the start time node; and releasing the target storage space at the end time node.

In an embodiment, a computer-readable storage medium is provided, having a computer program stored therein. When the computer program is executed by a processor, the following steps are implemented: obtaining shared memory state information and spill state information of virtual register data to be spilled, the shared memory state information including memory address data and memory capacity data of at least one workgroup; calculating available address data according to the memory capacity data, the available address data representing a remaining capacity of the shared memory; calculating a virtual register spill amount according to the spill state information; calculating a target storage space according to the virtual register spill amount and the memory address data; and determining a shared memory availability condition according to the available address data, and storing the virtual register data to be spilled in the target storage space when the target storage space meets the shared memory availability condition.

In an embodiment, when the computer program is executed by the processor, the following steps are further implemented: obtaining a shared memory base address according to the memory address data; calculating a memory offset address according to the memory capacity data and the shared memory base address; and determining the target storage space according to the virtual register spill amount and the memory offset address.

In an embodiment, when the computer program is executed by the processor, the following steps are further implemented: directly obtaining the shared memory base address according to the local address; calculating, when the shared memory base address does not exist, the shared memory base address according to the memory address data and the memory capacity data; and storing the shared memory base address in correspondence with the local address of the corresponding workgroup.

In an embodiment, when the computer program is executed by the processor, the following steps are further implemented: determining base address start data according to the total shared memory capacity and the currently occupied shared memory capacity; and calculating the shared memory base address according to the base address start data and the set memory capacity.

In an embodiment, when the computer program is executed by the processor, the following steps are further implemented: obtaining a life cycle of the virtual register data to be spilled; and storing the virtual register data to be spilled in the target storage space according to the life cycle.

In an embodiment, when the computer program is executed by the processor, the following steps are further implemented: storing the virtual register data to be spilled in the target storage space at the start time node; and releasing the target storage space at the end time node.

In an embodiment, a computer program product is provided, including a computer program. When the computer program is executed by a processor, the following steps are implemented: obtaining shared memory state information and spill state information of virtual register data to be spilled, the shared memory state information including memory address data and memory capacity data of at least one workgroup; calculating available address data according to the memory capacity data, the available address data representing a remaining capacity of the shared memory; calculating a virtual register spill amount according to the spill state information; calculating a target storage space according to the virtual register spill amount and the memory address data; and determining a shared memory availability condition according to the available address data, and storing the virtual register data to be spilled in the target storage space when the target storage space meets the shared memory availability condition.

In an embodiment, when the computer program is executed by the processor, the following steps are further implemented: obtaining a shared memory base address according to the memory address data; calculating a memory offset address according to the memory capacity data and the shared memory base address; and determining the target storage space according to the virtual register spill amount and the memory offset address.

In an embodiment, when the computer program is executed by the processor, the following steps are further implemented: directly obtaining the shared memory base address according to the local address; calculating, when the shared memory base address does not exist, the shared memory base address according to the memory address data and the memory capacity data; and storing the shared memory base address in correspondence with the local address of the corresponding workgroup.

In an embodiment, when the computer program is executed by the processor, the following steps are further implemented: determining base address start data according to the total shared memory capacity and the currently occupied shared memory capacity; and calculating the shared memory base address according to the base address start data and the set memory capacity.

In an embodiment, when the computer program is executed by the processor, the following steps are further implemented: obtaining a life cycle of the virtual register data to be spilled; and storing the virtual register data to be spilled in the target storage space according to the life cycle.

In an embodiment, when the computer program is executed by the processor, the following steps are further implemented: storing the virtual register data to be spilled in the target storage space at the start time node; and releasing the target storage space at the end time node.

A person of ordinary skill in the art may understand that implementation of all or part of the processes in the methods of the above embodiments may be completed by instructing the relevant hardware through a computer program. The computer program may be stored in a non-transitory computer-readable storage medium. When the computer program is executed, it may include the processes of the embodiments of the above methods. Any reference to memory, database or other medium used of the embodiments provided in the present disclosure may include at least one of a non-transitory or a transitory memory. The non-transitory memory may include a read-only memory (ROM), a magnetic tape, a floppy disk, a flash memory, an optical memory, a high-density embedded non-transitory memory, a resistive random-access memory (ReRAM), a magneto resistive random-access memory (MRAM), a ferroelectric random-access memory (FRAM), a phase change memory (PCM), or a graphene memory, etc. The transitory memory may include a random-access memory (RAM) or an external cache memory, etc. As an illustration rather than a limitation, the random-access memory may be in various forms, such as a static random-access memory (SRAM) or a dynamic random-access memory (DRAM), etc. The databases involved of the embodiments provided by the present disclosure may include at least one of a relational database and a non-relational database. The non-relational database may include, but is not limited to, a blockchain-based distributed database, etc. The processor involved of the embodiments provided by the present disclosure may be, but is not limited to, a general purpose processor, a central processor, a graphics processor, a digital signal processor, a programmable logic device, a data processing logic device based on quantum computation, and the like.

The technical features in the above embodiments may be combined arbitrarily. For concise description, not all possible combinations of the technical features in the above embodiments are described. However, provided that they do not conflict with each other, all combinations of the technical features are to be considered to be within the scope described in this specification.

The above-mentioned embodiments only describe several implementations of the present disclosure, and their description is specific and detailed, but should not be understood as a limitation on the patent scope of the present disclosure. It should be noted that, for a person of ordinary skill in the art may further make variations and improvements without departing from the conception of the present disclosure, and these all fall within the protection scope of the present disclosure. Therefore, the protection scope of the present disclosure should be subject to the appended claims.

What is claimed is:

1. A method for spilling data into a shared memory, the method comprising:
obtaining shared memory state information and spill state information of virtual register data to be spilled, the shared memory state information comprising memory address data and memory capacity data of at least one workgroup;
calculating available address data according to the memory capacity data, the available address data representing a remaining capacity of the shared memory;
calculating a virtual register spill amount according to the spill state information;
calculating a target storage space of the shared memory according to the virtual register spill amount and the memory address data;
determining a shared memory availability condition according to the available address data; and
storing the virtual register data to be spilled into the target storage space of the shared memory when the target storage space meets the shared memory availability condition.

2. The method according to claim 1, wherein calculating the target storage space according to the virtual register spill amount and the memory address data comprises:
obtaining a shared memory base address according to the memory address data;
calculating a memory offset address according to the memory capacity data and the shared memory base address; and
determining the target storage space according to the virtual register spill amount and the memory offset address.

3. The method according to claim 2, wherein the memory address data comprises a local address of a corresponding workgroup, and obtaining the shared memory base address according to the memory address data comprises:
directly obtaining the shared memory base address according to the local address;
calculating, when the shared memory base address does not exist, the shared memory base address according to the memory address data and the memory capacity data; and
storing the shared memory base address in correspondence with the local address of the corresponding workgroup.

4. The method according to claim 3, wherein the method is applied to a single processing element, the processing element comprises at least one workgroup, each workgroup comprises at least one work item, the memory capacity data comprises a total shared memory capacity of the processing element, a currently occupied shared memory capacity of each workgroup, and a set memory capacity of each work item in each workgroup, and calculating the shared memory base address according to the memory address data and the memory capacity data comprises:
determining base address start data according to the total shared memory capacity and the currently occupied shared memory capacity; and
calculating the shared memory base address according to the base address start data and the set memory capacity.

5. The method according to claim 1, wherein storing the virtual register data to be spilled into the target storage space of the shared memory comprises:
obtaining a life cycle of the virtual register data to be spilled; and
storing the virtual register data to be spilled into the target storage space of the shared memory according to the life cycle.

6. The method according to claim 5, wherein the life cycle comprises a start time node and an end time node, and storing the virtual register data to be spilled into the target storage space according to the life cycle comprises:
storing the virtual register data to be spilled into the target storage space at the start time node; and
releasing the target storage space at the end time node.

7. The method according to claim 1, wherein the shared memory state information is obtained from a logging module, in which storage change events occurring in a processing element is recorded.

8. The method according to claim 4, the available address data is calculated according to a total shared memory space of the single processing element, a shared memory space already occupied by programs, a shared memory space already occupied by local parameters, and a number of workgroups included in the processing element.

9. The method according to claim 1, wherein the shared memory availability condition is that the capacity of the target storage space is greater than or equal to the remaining capacity of the shared memory.

10. An apparatus for spilling data into a shared memory, the apparatus comprising:
an information obtaining module configured to obtain shared memory state information and spill state information of virtual register data to be spilled, the shared memory state information comprising memory address data and memory capacity data of at least one workgroup;
a capacity calculation module configured to calculate available address data according to the memory capacity data, the available address data representing a remaining capacity of the shared memory;
a spill amount calculation module configured to calculate a virtual register spill amount according to the spill state information;
a space determination module configured to calculate a target storage space according to the virtual register spill amount and the memory address data; and
a data storage module configured to determine a shared memory availability condition according to the available address data, and store the virtual register data to be spilled into the target storage space when the target storage space meets the shared memory availability condition.

11. A computer device comprising a memory and a processor, wherein the memory stores a computer program, the processor, when executing the computer program, implements operations for spilling data into a shared memory, the operations comprising:
obtaining shared memory state information and spill state information of virtual register data to be spilled, the shared memory state information comprising memory address data and memory capacity data of at least one workgroup;
calculating available address data according to the memory capacity data, the available address data representing a remaining capacity of the shared memory;
calculating a virtual register spill amount according to the spill state information;
calculating a target storage space of the shared memory according to the virtual register spill amount and the memory address data;
determining a shared memory availability condition according to the available address data; and
storing the virtual register data to be spilled into the target storage space of the shared memory when the target storage space meets the shared memory availability condition.

12. The computer device according to claim 11, wherein calculating the target storage space according to the virtual register spill amount and the memory address data comprises:
obtaining a shared memory base address according to the memory address data;
calculating a memory offset address according to the memory capacity data and the shared memory base address; and
determining the target storage space according to the virtual register spill amount and the memory offset address.

13. The computer device according to claim 12, wherein the memory address data comprises a local address of a corresponding workgroup, and obtaining the shared memory base address according to the memory address data comprises:
directly obtaining the shared memory base address according to the local address;
calculating, when the shared memory base address does not exist, the shared memory base address according to the memory address data and the memory capacity data; and
storing the shared memory base address in correspondence with the local address of the corresponding workgroup.

14. The computer device according to claim 13, wherein the operations are applied to a single processing element, the processing element comprises at least one workgroup, each workgroup comprises at least one work item, the memory capacity data comprises a total shared memory capacity of the processing element, a currently occupied shared memory capacity of each workgroup, and a set memory capacity of each work item in each workgroup, and calculating the shared memory base address according to the memory address data and the memory capacity data comprises:
determining base address start data according to the total shared memory capacity and the currently occupied shared memory capacity; and
calculating the shared memory base address according to the base address start data and the set memory capacity.

15. The computer device according to claim 11, wherein storing the virtual register data to be spilled into the target storage space of the shared memory comprises:
obtaining a life cycle of the virtual register data to be spilled; and
storing the virtual register data to be spilled into the target storage space of the shared memory according to the life cycle.

16. The computer device according to claim 15, wherein the life cycle comprises a start time node and an end time node, and storing the virtual register data to be spilled into the target storage space according to the life cycle comprises:
storing the virtual register data to be spilled into the target storage space at the start time node; and
releasing the target storage space at the end time node.

17. The computer device according to claim 15, wherein the shared memory state information is obtained from a logging module, in which storage change events occurring in a processing element is recorded.

18. The computer device according to claim 11, wherein the shared memory availability condition is that the capacity of the target storage space is greater than or equal to the remaining capacity of the shared memory.

19. A non-transitory computer-readable storage medium having a computer program stored therein, wherein when the computer program is executed by a processor, steps of the method of claim 1 are implemented.

20. A computer program product comprising a computer program, wherein when the computer program is executed by a processor, steps of the method of claim 1 are implemented.
